(19) United States
(12) Patent Application Publication
(10) Pub. No.: US 2026/0109242 A1
(43) Pub. Date: Apr. 23, 2026

(54) CHARGER

(71) Applicant: LG ELECTRONICS INC., Seoul (KR)

(72) Inventors: Jungyoun RUE, Seoul (KR); Junyeop JEONG, Seoul (KR); Bumseok SHON, Seoul (KR); Byeonghoon KIM, Seoul (KR); Myoungku LEE, Seoul (KR); Jihwan JO, Seoul (KR)

(73) Assignee: LG ELECTRONICS INC., Seoul (KR)

(21) Appl. No.: 19/208,242

(22) Filed: May 14, 2025

(30) Foreign Application Priority Data
Oct. 18, 2024 (KR) 10-2024-0143052

(51) Int. Cl. B60L 53/16; B60L 53/30; H01R 13/05; H01R 13/52

(52) U.S. Cl. CPC B60L 53/16; B60L 53/305; H01R 13/05; H01R 13/5202; H01R 2201/26

(57) ABSTRACT

Provided is a charger. The charger comprises a charger body; a contact pin accommodated in the charger body; and a module detachably coupled to a rear surface of the charger body. The module comprises a housing having a space formed in the housing; and a contact terminal installed inside the housing and contacting the contact pin.

### CROSS-REFERENCE TO RELATED APPLICATION

Pursuant to 35 U.S. C. § 119(a), this application claims the benefit of earlier filing date and right of priority to Korean Patent Application No. 10-2024-0143052, filed on Oct. 18, 2024, the contents of which are hereby incorporated by reference herein in its entirety.

### BACKGROUND

The present invention relates to a charger capable of charging a vehicle such as an electric vehicle.

A charger is a device used to charge a battery.

An example of a charger may be an electric vehicle charger that charges a vehicle such as an electric vehicle, and electric energy is supplied to the battery of the electric vehicle by connecting the charging connector provided at the end of the charging cable to the connection inlet installed in the electric vehicle.

Korean Patent Publication No. 10-2018-0061635 A (June 8, 2018, published) discloses an electric vehicle charger, and the electric vehicle charger comprises a charging connector that connects to a charging inlet of an electric vehicle to supply electric energy to a battery of the electric vehicle, a plug that is connected to the charging connector via a wire cable and connects to a commercial power source, and a charging control box that comprises a Bluetooth module for communication with an external smartphone.

### SUMMARY

The present embodiment relates to a charger capable of servicing a module comprising contact terminals without opening or disassembling the charger body.

In one embodiment, a charger comprises; a charger body; a contact pin accommodated in the charger body; and a module detachably coupled to a rear surface of the charger body, the module comprises: a housing having a space formed in the housing; a contact terminal installed inside the housing and contacting the contact pin.

The module may further comprise a gland coupled to the housing and through which an inlet cable passes.

The gland may comprise a bolt penetrating the housing and through which the inlet cable passes

The module may comprise a nut accommodated inside the housing and fastened to the bolt.

The contact pin may be a bus bar.

The contact terminal comprises an elastic body with which the contact pin may come into contact.

The charger body may comprise a sliding guide guiding the housing to slide in an up and down direction.

The contact pins may be disposed long in the up and down direction.

When the housing rises, the contact terminal may come into contact with the contact pins.

The housing comprises a first fastening portion through which a fastening member passes, and the charger body may comprise a second fastening portion facing the first fastening portion and to which the fastening member is fastened.

The charger body may comprise a cover body concealing the contact pin.

A lower portion of the module may protrude forward.

The module may comprise a cover covering the space; an inner waterproof gasket disposed between the cover and the housing; and an upper waterproof gasket disposed at an upper end of the housing.

The charger body may comprise a rear body; and a front body disposed in front of the rear body.

An inner space may be formed between the rear body and the front body.

The front body may comprise a front body portion; an upper body portion formed at an upper end of the front body portion; and a lower body portion formed at a lower end of the front body portion.

The charger body may further comprise an upper deco covering the upper portion of the front body portion; and a lower deco covering the lower portion of the front body portion.

The charger may further comprise a touch display disposed in the middle of the front body portion.

A height of the touch display may be lower than a lower height of the upper deco.

A height of the touch display may be higher than an upper height of the lower deco.

The charger further may comprise a connector holder disposed in the front body portion.

An opening through which a connector of a charging cable passes may be formed in the lower deco and the front body portion.

The charger may further comprise a speaker disposed in the front body portion.

An inner speaker hole may be formed in the lower body portion.

The lower deco may comprise a lower deco portion disposed below the lower body portion.

An outer speaker hole may be formed in the lower deco portion.

The charger further may comprise a mounter fixed to a wall. A mounting portion mounted on the mounter may be provided on a rear surface of the rear body.

The charger further comprising a frame accommodated in the inner space; a rear waterproof pad waterproofing between the rear body and the frame; and a front waterproof pad waterproofing between the frame and the front body.

The rear body is provided with a first rib protruding forward, and a second rib protruding forward and spaced apart from the first rib in a left and right direction.

The front body may be provided with a third rib inserted into a gap between the first rib and the second rib.

The charger further comprises a supporter coupled to the rear body; and a power board connected to the supporter, and the contact pin may be connected to the power board.

The charger further comprises a power board accommodated inside the charger body; a spacer connected to the power board; and a control board connected to the spacer and spaced apart from the power board in a front and rear direction, the power board and the control board may be connected by a harness.

### BRIEF DESCRIPTION OF THE DRAWINGS

FIG. 1 is a front view of a charger according to the present embodiment,

FIG. 2 is a side view showing one side of a charger according to the present embodiment,

FIG. 3 is a side view showing the other side of a charger according to the present embodiment,

FIG. 4 is a rear view of a charger according to the present embodiment,

FIG. 5 is a view of a charger according to the present embodiment when it is mounted on a wall,

FIG. 6 is a view of a module according to the present embodiment before it is fastened to a cabinet body,

FIG. 7 is a view of a module according to the present embodiment when it is fully fastened to a cabinet body,

FIG. 8 is an exploded perspective view of a module according to the present embodiment,

FIG. 9 is a view showing the inside of a module according to the present embodiment,

FIG. 10 is a perspective view showing a contact terminal according to the present embodiment,

FIG. 11 is an exploded perspective view of a charger according to the present embodiment,

FIG. 12 is a back view of a front body according to the present embodiment,

FIG. 13 is a view taken along line A-A of FIG. 12. Cross-sectional view,

FIG. 14 is a front view of a rear body according to the present embodiment,

FIG. 15 is a perspective view showing a power board and a control board according to the present embodiment,

FIG. 16 is a cross-sectional view showing a rear body, a frame and a front frame according to the present embodiment,

FIG. 17 is a first modified example of a module according to the present embodiment,

FIG. 18 is a second modified example of a module according to the present embodiment,

FIG. 19 is a third modified example of a module according to the present embodiment,

FIG. 20 is a modified example of a charger according to the present embodiment.

### DETAILED DESCRIPTION OF THE EMBODIMENTS

Hereinafter, detailed embodiments will be described in detail with reference to the accompanying drawings.

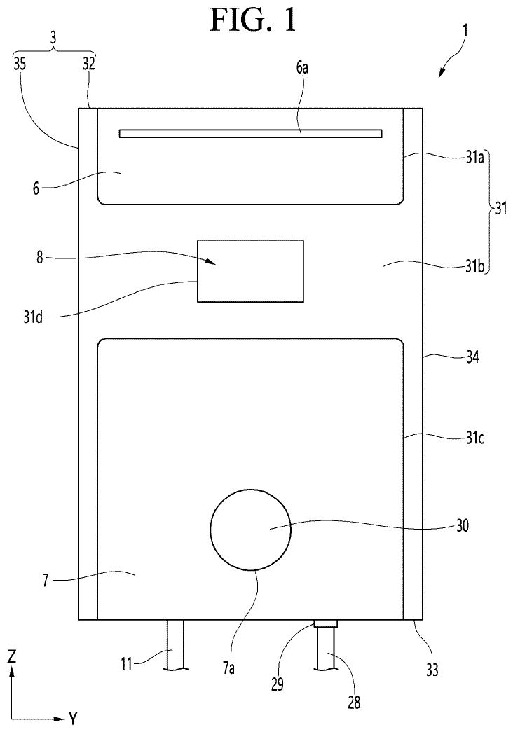

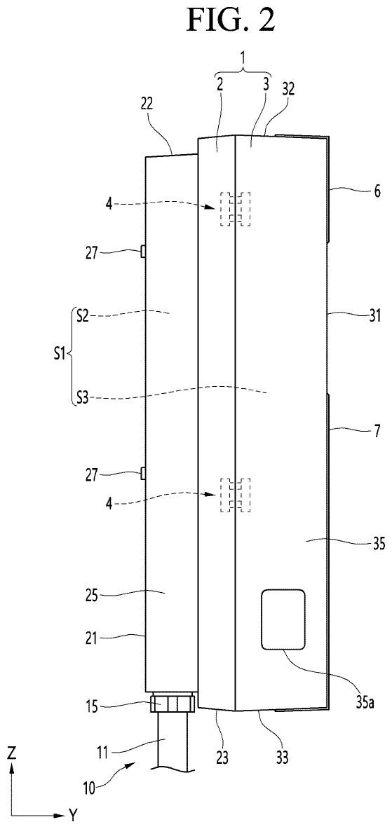

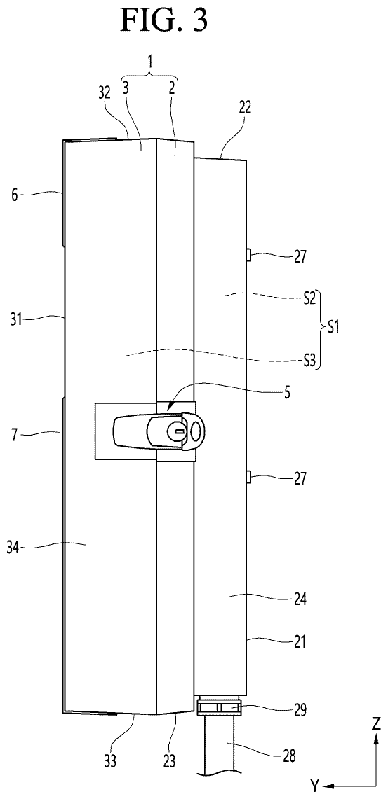

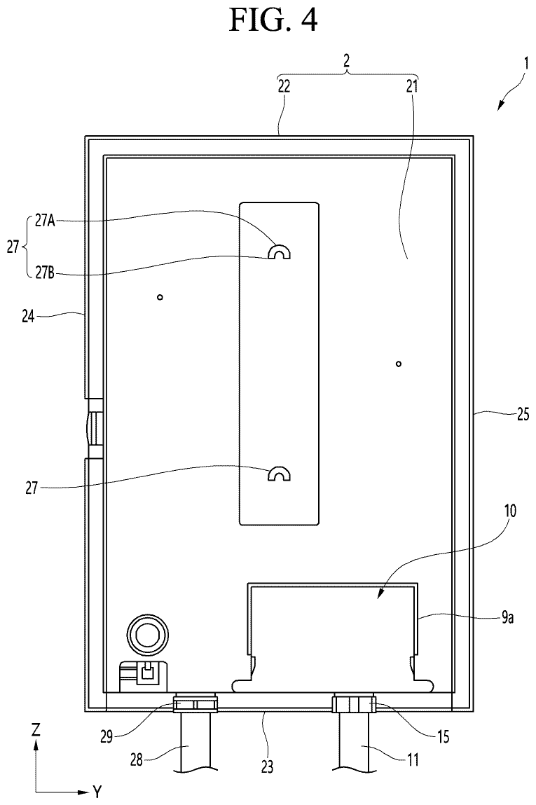

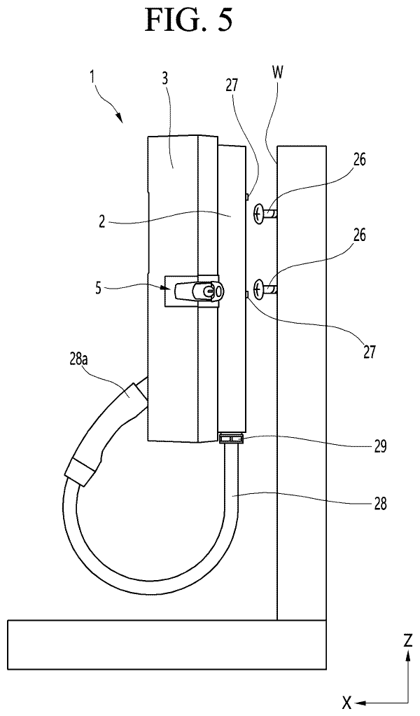

FIG. 1 is a front view of a charger according to the present embodiment, FIG. 2 is a side view showing one side of a charger according to the present embodiment, FIG. 3 is a side view showing the other side of a charger according to the present embodiment, FIG. 4 is a rear view of a charger according to the present embodiment, and FIG. 5 is a view of a charger according to the present embodiment when it is mounted on a wall.

The charger may comprise a charger body 1.

The charger body 1 may form the exterior of the charger. The charger body 1 may have a rectangular hexahedron shape that is elongated in the up and down direction Z. An inner space S1 may be formed inside the charger body 1.

The charger body 1 may be composed of an assembly of a plurality of members.

The charger body 1 may comprise a rear body 2 and a front body 3, and an inner space S1 may be formed between the rear body 2 and the front body 3.

The rear body 2 may form the rear and side exteriors of the charger.

The rear body 2 may comprise a rear body portion 21, an upper body portion 22, and a lower body portion 23.

The front of the rear body 2 may be opened, and a rear inner space S2 may be formed inside the rear body 2.

The upper body portion 22 may be formed at the upper end of the rear body portion 21. The upper body portion 22 may be the rear upper body portion of the charging body 1.

The lower body portion 23 may be formed at the lower end of the rear body portion 21. The lower body portion 23 may be the rear lower body portion of the charging body 1.

The rear body 2 may further comprise a left body portion 24 and a right body portion 25.

The left body portion 24 may be formed at the left end of the rear body portion 21. The left body portion 24 may be the rear left body portion of the charging body 1.

The right body portion 25 may be formed at the right end of the rear body portion 21. The right body portion 25 may be the rear right body portion of the charging body 1.

An example of the charger may be a wall-mounted charger. The charger may be mounted on a mounter 26 that is fixed to a wall W.

An example of the mounter 26 may comprise a screw. An example of the mounter 26 may further comprise a wall-mounted anchor.

The wall-mounted anchor may be inserted into and fixed to the wall W, and the screw may be inserted into and fixed to the wall-mounted anchor.

A plurality of mounters 26 may be fixed to the wall W. A plurality of mounters 26 may be spaced apart in the up and down direction Z.

The charger body 1 may be provided with a mounting portion 27 that is mounted on the mounter 26. A mounting portion 27 may be provided on the rear body 2. The mounting portion 27 may be formed on the rear surface of the rear body 2. The mounting portion 27 may protrude from the rear surface of the rear body 2. The mounting portion 27 may be formed on the rear body portion 21 of the rear body 2.

The mounting portion 27 may comprise a mounting portion 27A having an arc shape or a semicircular shape.

The mounting portion 27A may be mounted on the mounter 26.

The mounting portion 27 may further comprise a guide portion 27B that is guided to slide in the up and down direction Z on the mounter 26.

The guide portion 27B may extend downward from the mounting portion 27A. The guide portions 27B may extend in pairs from the mounting portion 27A.

The lower end of the mounting portion 27 may be opened.

When attaching the charger to the wall W, the mounting portion 27 may be positioned on the upper side of the mounter 26, then moved downward, and may be mounted on the mounter 26.

The mounting portion 27 may correspond 1:1 with the mounter 26. A plurality of mounting portions 27 may be formed on the rear surface of the rear body 2. The plurality of mounting portions 27 may be spaced apart in the up and down direction Z.

A plurality of mounters 26 may be fixed to the wall W, and a plurality of mounting portions 27 may be mounted on a plurality of mounters 26.

When the mounting portion 27 is mounted on the mounter 26, the charger body 1 may be spaced apart from the ground in the up and down direction Z, and a gap may be formed between the charger body 1 and the ground in which the inlet cable 11 and the charging cable 28 may be positioned.

The charger may comprise a charging cable 28 and a charging gland 29 through which the charging cable 28 passes.

One end of the charging cable 28 may be positioned inside the charger body 1, the charging cable 28 may pass through the charging gland 29, and the other end of the charging cable 28 may be positioned outside the charger body 1.

The charging cable 29 may be extended downward through the charging gland 29.

The other end of the charging cable 28 may be provided with a connector 28a (coupler or charging gun). The connector 28a may be detachably connected to a vehicle such as an electric vehicle.

The charging gland 29 may be disposed in the rear body 2 or the front body 3.

The charging gland 29 may be disposed in the rear body 2 and may be disposed in the lower body portion 23 of the lower body 2.

The front body 3 may be disposed in front of the rear body 2. The front body 3 may form the front and side appearances of the charger.

The front body 3 may comprise a front body portion 31, an upper body portion 32, and a lower body portion 33.

The rear of the front body 3 may be opened, and a front inner space S3 may be formed inside the front body 3.

The front body portion 31 may be divided into an upper portion 31a, a center portion 31b, and a lower portion 31c.

The upper body portion 32 may be formed at the upper end of the front body portion 31. The upper body portion 32 may be a front upper body portion formed from the upper end of the front body portion 31 to the rear.

The lower body portion 33 may be formed at the lower end of the front body portion 31. The lower body portion 33 may be a front lower body portion formed from the lower end of the front body portion 31 to the rear.

The front body 3 may further comprise a left body portion 34 and a right body portion 35.

The left body portion 34 may be a front left body portion formed from the left end of the front body portion 31 to the rear.

The right body portion 35 may be a front right body portion formed from the left end of the front body portion 31 to the rear.

The front body 3 may be rotatably disposed in front of the rear body 2.

The front body 3 may be connected to the rear body 2 by a hinge 4.

The hinge 4 may be a hidden hinge installed inside the charger body 1. The hinge 4 may comprise a rear hinge connected to the rear body 2, a front hinge connected to the front body 3, and a connecting hinge connected to the rear hinge and the front hinge.

The connecting hinge may be rotatably connected to at least one of the rear hinge and the front hinge.

The front body 3 may be locked to the rear body 2 by a locking device 5.

The locking device 5 may be mounted on the rear body 2. The locking device 5 may comprise a locking member that is locked or unlocked to the front body 3.

An example of the locking device 5 may be a cicada head locking device.

The charging body 1 may comprise an upper deco 6 and a lower deco 7.

The upper deco 6 may cover the upper portion 31a of the front body portion 31. The upper deco 6 may cover a portion of the upper portion 31a of the front body portion 31.

The upper deco 6 may cover the upper portion 31a of the front body portion 31 and the upper body portion 32 of the front body 3.

A light-transmitting portion 6a may be formed in the upper deco 6. The light transmitting portion 6a may be formed transparently or translucently. The light transmitting portion 6a may be formed long in the left and right direction Y on the upper deco 6. Light generated from an LED module (not shown) disposed inside the cabinet body 1 may transmit through the light transmitting portion 6a.

The portion of the upper deco 6 other than the light transmitting portion 6a can be formed opaque.

The upper portion 31a of the front body portion 31 may be an upper concealed portion that is concealed and protected by the upper deco 6.

The lower deco 7 may cover the lower portion 31c of the front body portion 31. The lower deco 7 may cover a portion of the lower portion 31c of the front body portion 31.

The lower deco 7 may cover the lower portion 31c of the front body portion 31 and the lower body portion 33 of the front body 3.

The lower deco 7 may be formed opaquely.

The upper end of the lower deco 7 may be spaced apart from the lower end of the upper deco 6.

The size of the lower deco 7 may be larger than the size of the upper deco 6.

The lower portion 31c of the front body portion 31 may be a lower concealed portion that is concealed and protected by the lower deco 7.

The charger may further comprise a connector holder 30 (holster) in which a connector 28a is mounted.

The connector holder 30 may be disposed in the lower portion 31c of the front body portion 31. The connector holder 30 may be disposed on the rear surface of the lower portion 31c of the front body portion 31.

An opening 7a through which a connector 28a can pass may be formed in the lower deco 7. The opening 7a may be an opening for a connector formed in the lower deco 7.

The connector 28a may be inserted into the connector holder 30 through the opening 7a of the lower deco 7 and may be mounted on the connector holder 30.

The charger may further comprise a touch display 8.

The touch display 8 may be disposed in the front body portion 31. The touch display 8 may be disposed to be exposed to the outside in the front body portion 31.

The middle portion 31b of the front body portion 31 may be an exposed portion not covered by the upper deco 6 or the lower deco 7.

The touch display 8 may be disposed in the middle portion 31b of the front body portion 31.

The touch display 8 may comprise a display unit such as an LCD, LED, etc., and a touch screen disposed on the front of the display unit.

An opening 31d may be formed in the front body portion 31. The front of the touch screen may be exposed to the outside through the opening 31d. The opening 31d may be formed in the middle portion 31b of the front body portion 31. The height of the opening 31d may be lower than the lower end of the upper deco 6 and higher than the upper end of the lower deco 7. The opening 31d may be an opening for a touch display formed in the middle portion 31b of the front body portion 31.

The charger may further comprise a module 10.

An inlet cable 11 may be extended into the interior of the module 10. The inlet cable 11 may be connected to a commercial power source. The inlet cable 11 may be a cable for supplying current to the charger.

The module 10 may be an assembly of a plurality of members. The module 10 may be a gland module through which the inlet cable 11 passes.

The module 10 may be detachably coupled to the charger body 1.

The module 10 may be coupled to the charger body 1 from the outside of the charger body 1.

The module 10 may be detachably coupled to at least one of the left surface, the right surface, and the rear surface of the charger body 1.

An example of the module 10 may be detachably coupled to the rear surface of the charger body 1. The module 10 may be a rear module, and may simplify the appearance of the front surface, left surface, and right surface of the charger.

Another example of the module 10 may be detachably coupled to one of the left surface and the right surface of the charger body 1. The module 10 may be a side module, and the front and back appearances of the charger may be simple.

Hereinafter, the module 10 is described as a rear module.

A mounting portion may be formed in the charger body 1 into which the module 10 may be inserted and mounted.

The charger body 1 may comprise a sliding guide 9a. The mounting portion may be formed on the inside of the sliding guide 9a.

The remaining components, excluding the module 10 in the charger, may form the charging body.

The owner of the charger may separate the charging body from the module 10 while keeping the module 10 in the charger installation location, and may service it with a new charging module or replace the charging body with a new model.

In this case, the module 10 may be used in common, and when servicing it with a new charging module or replacing it with a new model, there is no need to separately construct the inlet cable 11, and setup of the inlet line, etc. may be unnecessary. This means that the owner of charger may save money and time.

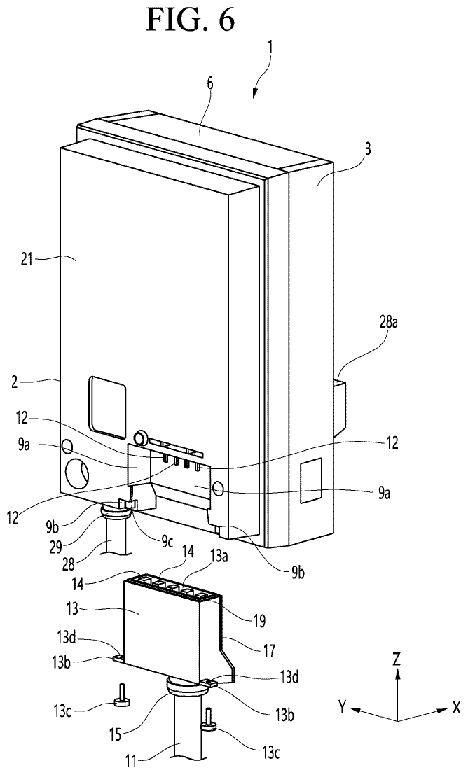

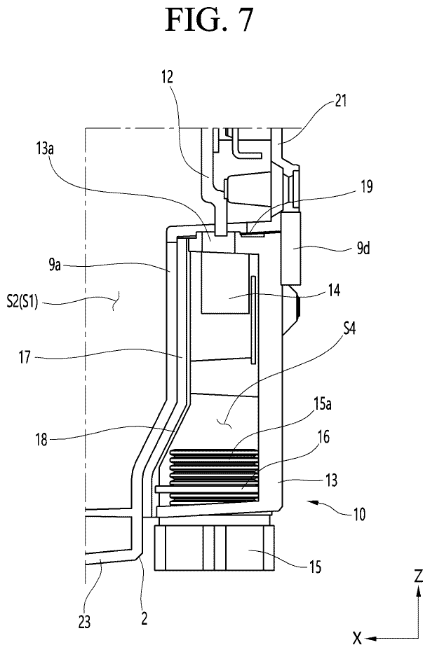

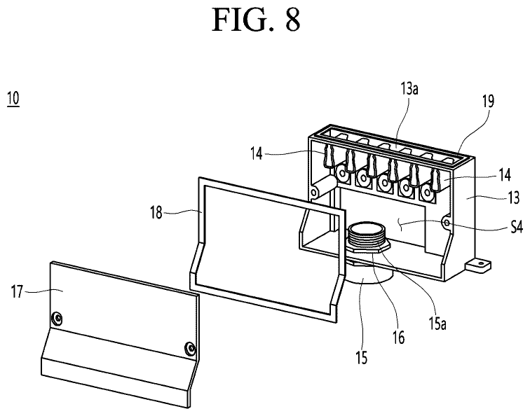

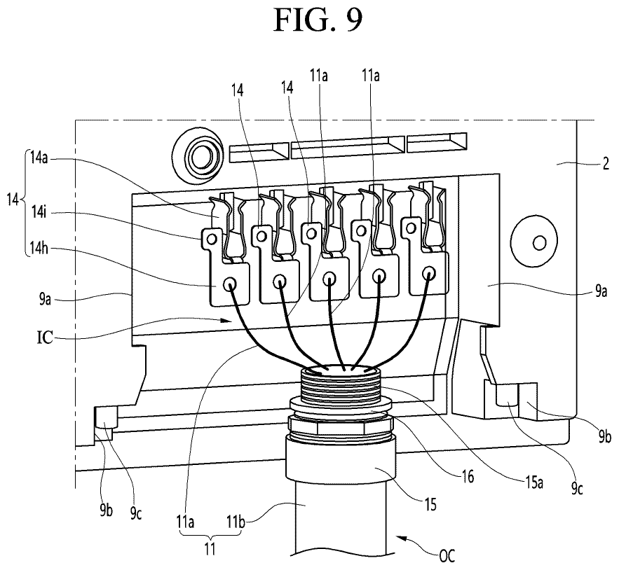

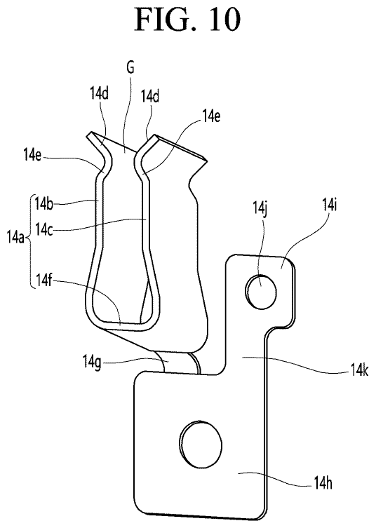

FIG. 6 is a view of a module according to the present embodiment before it is fastened to a cabinet body, FIG. 7 is a view of a module according to the present embodiment when it is fully fastened to a cabinet body, FIG. 8 is an exploded perspective view of a module according to the present embodiment, FIG. 9 is a view showing the inside of a module according to the present embodiment, and FIG. 10 is a perspective view showing a contact terminal according to the present embodiment,

The sliding guide 9a may guide the module 10 in the up and down direction Z so that the module 10 slides in the up and down direction Z.

The sliding guide 9a may be formed in a recessed shape in the charger body 1.

The sliding guide 9a may be formed in the rear body 2. The upper and lower surfaces of the sliding guide 9a may be opened, respectively.

The sliding guide 9a may comprise a left guide in which the left side of the module 10 is guided, and a right guide in which the right side of the module 10 is guided.

The sliding guide 9a may further comprise a front guide in which the front surface of the module 10 is guided.

The charger may comprise a contact pin 12.

The contact pin 12 may be disposed in the charger body 1. The contact pin 12 may be accommodated inside the charger body 1.

The contact pin 12 may be connected to a power board (not shown) described later.

The contact pin 12 may be disposed to be long in the up and down direction Z.

The contact pin 12 may be extended from the inside of the charger body 1 into the inside of the sliding guide 9a. The contact pin 12 may be extended into the inside of the sliding guide 9a through the upper surface of the sliding guide 9a.

The lower end of the contact pin 12 may be accommodated inside the sliding guide 9a.

An example of the contact pin 12 may be a bus bar through which current may pass. When the module 10 is mounted, the contact pin 12 may be in contact with the contact terminal 14 described later.

The number of contact pins 12 may be the same as the number of contact terminals 14. A plurality of contact pins 12 may be accommodated in the charger body 1. A plurality of contact pins 12 may be spaced apart from each other in the left and right direction Y.

The contact pins 12 may be electrically separated from the module 10 when the module 10 is separated from the charger body 1, and may be in an electrically non-hazardous state.

The module 10 may comprise a housing 13 and a contact terminal 14.

The housing 13 may form an exterior of the module 10.

A space S4 may be formed inside the housing 13. The front of the housing 13 may be open. An opening 13a may be formed on the upper surface of the housing 13. The opening 13a may be an opening for a contact pin through which a contact pin 12 passes.

When the module 10 is mounted on the cabinet body 1, the contact pin 12 may penetrate the opening 13a and be connected by contacting the contact terminal 14 disposed inside the housing 13.

The housing 13 may comprise a first fastening portion 13b. The first fastening portion 13b may be fastened to the charger body 1. The first fastening portion 13b may be fastened to the rear body 2. A through hole 13d through which a fastening member 13c such as a screw passes may be formed in the first fastening portion 13b.

The first fastening portion 13b may be formed at the lower portion of the housing 13. The first fastening portion 13b may protrude from the side surface of the housing 13.

A plurality of first fastening portions 13b may be formed in the housing 13. The plurality of first fastening portions 13b may comprise a left fastening portion formed on the left side of the housing 13 and a right fastening portion formed on the right side of the housing 13.

A receiving groove 9b in which the first fastening portion 13b is received may be formed in the charger body 1.

The receiving groove 9b may be formed to be recessed upward in the charger body 1. The receiving groove 9b may be formed in the rear body 2. The first fastening portion 13b may be inserted into the receiving groove 9b from the lower side of the receiving groove 9b and may be received in the receiving groove 9b. The number of receiving grooves 9b may be the same as the number of first fastening portions 13b. A plurality of receiving grooves 9b may be formed in the rear body 2. The plurality of receiving grooves 9b may comprise a left receiving groove in which the left fastening portion is received and a right receiving groove in which the right fastening portion is received.

A second fastening portion 9c may be formed in the charger body 1, and the housing 13 may be fastened to the second fastening portion 9c.

The second fastening portion 9c may be formed in the rear body 2.

The second fastening portion 9c may face the first fastening portion 13b. The second fastening portion 9c may face to the first fastening portion 13b in the up and down direction Z. The second fastening portion 9c may be formed inside the receiving groove 9b. A fastening member 13c penetrating the first fastening portion 13b may be fastened to the second fastening portion 9c. An example of the second fastening portion 9c may be a fastening boss formed in the charger body 1, particularly the rear body 2. The number of fastening bosses may be the same as the number of the first fastening portion 13b. A plurality of fastening bosses may be formed on the rear body 2. The plurality of fastening bosses may comprise a left fastening boss facing the left fastening portion and a right fastening boss facing the right fastening portion.

When the housing 13 is inserted from the lower side to the inside of the sliding guide 9a, the housing 13 may be inserted into the inside of the sliding guide 9a, the first fastening portion 13b may be accommodated in the receiving groove 9b, and the first fastening portion 13b may be aligned with the second fastening portion 9c in the upper and lower direction Z.

A worker or a robot may fasten the first fastening portion 13b and the second fastening portion 9c with a fastening member 13c such as a screw, and the module 10 mounting operation may be completed.

The contact terminal 14 may be installed in the housing 13. The contact terminal 14 may be accommodated in the space S4 of the housing 13. The contact terminal 14 may be protected by the housing 13.

Even if the module 10 is separated from the charger body 1, the contact terminal 14 may be maintained inside the module, and the risk to the worker may be minimized.

A terminal fastening portion to which the contact terminal 14 is fastened may be formed in the housing 13.

The terminal fastening portion may be formed on the front surface of the rear plate of the housing 13. An example of the terminal fastening portion may be a fastening boss to which a fastening member such as a screw is fastened.

The number of terminal fastening portions may be the same as the number of contact terminals 14 accommodated in the housing 13.

The contact terminal 14 may be in contact with the contact pin 12.

When the housing 13 is raised, the contact terminal 14 may be in contact with the contact pin 12. When the housing 13 is lowered, the contact terminal 14 may be separated from the contact pin 12.

The contact terminal 14 may comprise an elastic body 14a with which the contact pin 12 is in contact.

The elastic body 14a may be elongated in the up and down direction Z. The upper end of the elastic body 14a may be opened.

A gap G into which the contact pin 12 may be inserted may be formed in the elastic body 14a.

The elastic body 14a may comprise a pair of side bodies 14b and 14c.

The gap G may be formed between the pair of side bodies 14b and 14c. The gap G may be formed long in the up and down direction Z between the pair of side bodies 14b and 14c.

A pair of side bodies 14b and 14c may face each other in the left and right direction Y.

A pair of side bodies 14b and 14c may comprise a contact surface that comes into contact with a contact pin 12.

Each of the pair of side bodies 14b and 14c may comprise an inlet region 14d into which a contact pin 12 enters. The inlet region 14d of each of the pair of side bodies 14b and 14c may be formed to become closer to each other as they go downward, and the inlet region 14d may comprise an inclined surface on which the contact 12 slides.

Each of the pair of side bodies 14b and 14c may comprise an overlap region 14e that overlaps the inlet region 14a in the up and down direction Z.

The contact pin 12 may slide along the inclined surface of the inlet area 14d and maintain contact with the elastic body 14a.

The elastic body 14a may further comprise a lower body 14f.

The lower body 14f may connect the lower ends of a pair of side bodies 14b and 14c.

A first bridge 14g may be connected to the elastic body 14a. The first bridge 14g may be connected to the lower body 14f.

The contact terminal 14 may comprise a coupling body 14h to which an inlet line 11a of an inlet cable 11 is connected.

The first bridge 14g may be connected to the coupling body 14h.

The contact terminal 14 may further comprise a coupling body 14i that is connected to the housing 13. The coupling body 14i may be fastened to the housing 13 by a fastening member such as a screw. A through hole 14j through which a fastening member such as a screw penetrates may be formed in the coupling body 14i.

The through hole 14j may be a fastening hole that minimizes the contact terminal 14 from being randomly rotated.

The coupling body 14i may be fastened to a terminal fastening portion formed in the housing 13 by a fastening member.

The coupling body 14i may be connected to the connection body 14h by a second bridge 14k.

A plurality of contact terminals 14 may be provided inside the housing 13. The plurality of contact terminals 14 may be disposed in a row. The plurality of contact terminals 14 may be spaced apart in the left and right direction Y. A gap may be formed between adjacent contact terminals 14.

If some of the contact terminals 14 are deformed or corroded, only the deformed or corroded contact terminals 14 may be replaced.

A new model of the charger may have a different number of inlet lines 11a from the previous module, and in this case, the number of contact terminals 14 accommodated in the housing 13 may be changed, and the module 10 may be applied to various models.

For example, if a signal line for communication or a ground line is added to the inlet cable 11 of a new model, the number of contact terminals 14 may be increased, and the module 10 may correspond to a model with an added signal line or ground line.

The module 10 may further comprise a gland 15.

The gland 15 may be coupled to the housing 13. The inlet cable 11 may pass through the gland 15.

The inlet cable 11 may pass through the gland 15 and may be connected to a contact terminal 14.

The inlet cable 11 may comprise an inlet line 11a and an outer shell 11b surrounding the inlet line 11a.

The inlet lines 11a may be provided in plurality inside the outer shell 11b.

An example of the plurality of inlet lines 11a may comprise an R phase, an N phase (neutral phase), and a G phase Ground, and the inlet cable 11 may be a single-phase and 3-line cable and may have a capacity of 11 KW.

Another example of the plurality of inlet lines 11a may comprise R phase, S phase, N phase (neutral phase), and G phase Ground, and the inlet cable 11 may be a two-phase and four-line cable and may have a capacity of 19.2 KW.

The other example of the plurality of inlet lines 11a may comprise R phase, S phase, T phase, N phase (neutral phase), and G phase Ground, and the inlet cable 11 may be a three-phase and five-line cable and may have a capacity of 22 KW.

The outer shell 11b may surround a portion of the inlet cable 11.

The portion of the inlet line 11a that is not surrounded by the outer shell 11b may form an inner inlet cable IC accommodated inside the housing 1.

The other portion of the inlet line 11a surrounded by the outer shell 11b, and the outer shell 11b may constitute an outer inlet cable OC.

The gland 15 may comprise a bolt 15a.

The bolt 15a may penetrate the housing 13.

The inlet cable 11 may penetrate the bolt 15a.

The module 10 may comprise a nut 16.

The nut 16 may be accommodated inside the housing 13 and fastened to the bolt 15a.

The charger body 1 may comprise a cover body 9d that conceals the contact pin 12.

The cover body 9d may be a rib that is removably formed on the rear body 2. The cover body 9d may be a concealing rib that hides the contact pin 12 from view when the rear body 2 is viewed from the rear of the charger body 1.

The cover body 9d may face the sliding guide 9a in the front and rear direction X.

When the module 10 is separated, the cover body 9d may minimize the exposure of a portion of the contact pin 12.

The lower end of the contact pin 12 may extend to the inside of the sliding guide 9a, and the cover body 9d may cover the lower end of the contact pin 12 so that it is not exposed to the outside while being spaced apart from the lower end of the contact pin 12 in the front and rear direction X.

Even if the module 10 is removed, the cover body 9d may prevent the exposure of the contact pin 12 and minimize the worker's hand from touching the contact pin 12.

If repair of the contact pin 12 is required, the cover body 9d may be removed from the charger body 1, and failure analysis and response of the contact pin 12 may be possible.

A bolt 15 and a nut 16 may be accommodated in the lower portion of the module 10, and a contact terminal 14 may be accommodated in the upper portion of the module 10, and the length in the front and rear direction X of the lower portion of the module 10 may be longer than the length in the front and rear direction X of the upper portion of the module 10. The lower portion of the module 10 may protrude forward.

The module 10 may further comprise a cover 17 covering the space S4 of the housing 13; an inner waterproof gasket 18 disposed between the cover 17 and the housing 13; and an upper waterproof gasket 19 disposed on the upper end of the housing 13.

The cover 17 may shield the space S4 of the housing 13.

The cover 17 may be disposed between the charger body 1 and the housing 13.

The cover 17 may be fastened to the housing 13 with a fastening member such as a screw.

The contact terminal 14 is connected to the inlet line 11a and current is flowing, and the contact terminal 14 and the inlet line 11a may be surrounded by the housing 13 and the cover 17.

The inner waterproof gasket 18 may minimize rainwater, etc. from penetrating through the space between the cover 17 and the housing 13.

The inner waterproof gasket 18 may seal the space between the cover 17 and the housing 13. The inner waterproof gasket 18 may be fixed by a fastening member such as a screw that fixes the cover 17 to the housing 13.

The upper waterproof gasket 19 may minimize the penetration of rainwater, etc., through the space between the charger body 1 and the housing 13.

The upper waterproof gasket 19 may seal the space between the rear body 2 and the housing 13.

When the housing 13 is fixed to the rear body 2 by a fastening member 13c such as a screw, the upper waterproof gasket 19 may be maintained between the rear body 2 and the housing 13.

The module 10 may be fixed and sealed by a gasket attached between each mechanism and a fastening member such as a screw.

The module 10 may be freely disassembled and assembled for manufacturing and maintenance by applying inner waterproof gasket 18 and upper waterproof gasket 19.

The structure of upper waterproof gasket 19 disposed between module 10 and rear body 2 may be simple, and components may be shared by model.

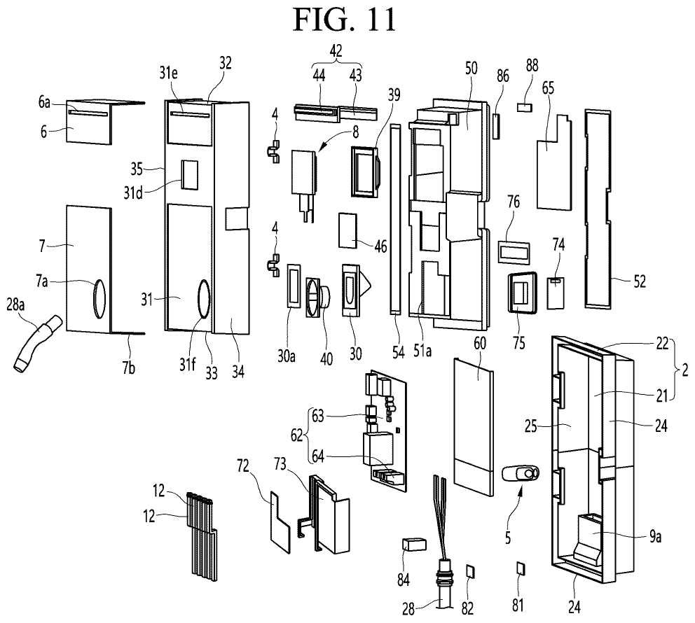

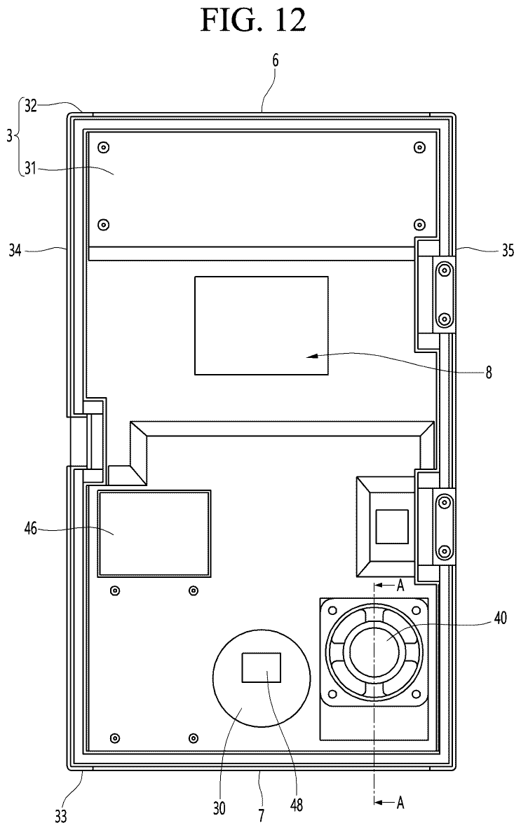

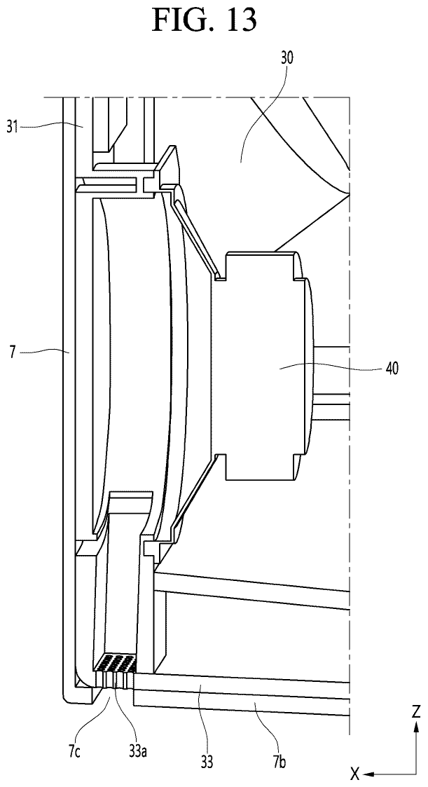

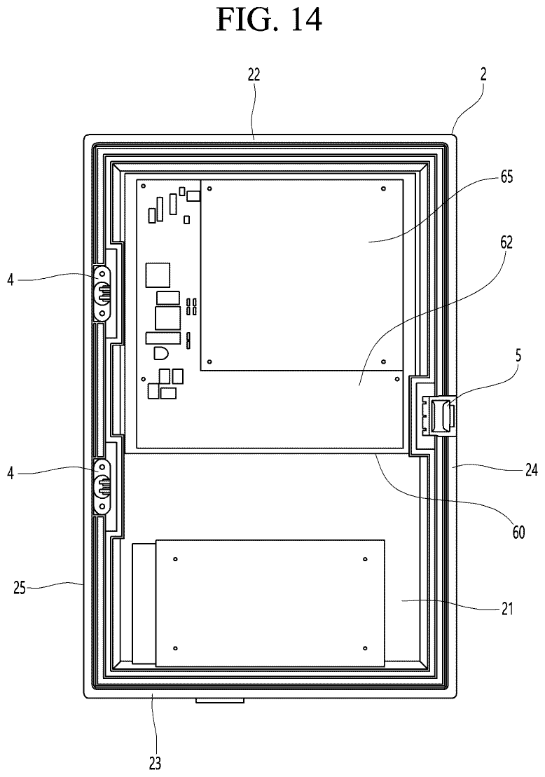

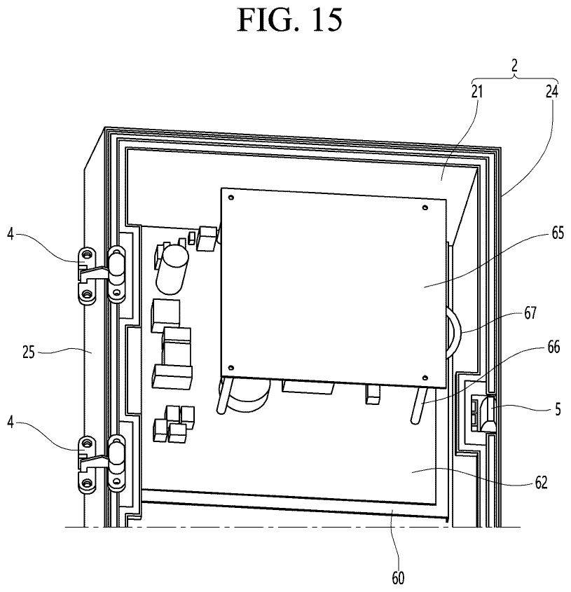

FIG. 11 is an exploded perspective view of a charger according to the present embodiment, FIG. 12 is a back view of a front body according to the present embodiment, FIG. 13 is a view taken along line A-A of FIG. 12. Cross-sectional view, FIG. 14 is a front view of a rear body according to the present embodiment, and FIG. 15 is a perspective view showing a power board and a control board according to the present embodiment.

The connector holder 30 may be disposed on the rear surface of the front body portion 31 of the front body 3.

A waterproof pad 30a may be disposed between the front body portion 31 of the front body 3 and the connector holder 30.

An opening 31f through which a connector 28a of the charging cable 28 passes may be formed in the front body portion 31 of the front body 3.

The charger may further comprise a touch display bracket 39 that supports the touch display 8. The touch display 8 may be accommodated in the touch display bracket 39.

The touch display bracket 39 may be disposed on the rear surface of the front body portion 31 of the front body 3. The touch display bracket 39 may protect the touch display 8.

The charger may further comprise a speaker 40 disposed in the front body portion 31.

The speaker 40 may be disposed on the rear surface of the front body portion 31. The speaker 40 may be attached to the rear surface of the front body portion 31 using a fastening member such as a screw.

As shown in FIG. 13, an inner speaker hole 33a may be formed in the lower body portion 33 of the front body 3. The inner speaker hole 33a may be opened in the up and down direction Z of the lower body portion 33. A plurality of inner speaker holes 33a may be formed in the lower body portion 33.

As shown in FIG. 13, the lower deco 7 may comprise a lower deco portion 7b disposed on the lower side of the lower body portion 33. An outer speaker hole 7c may be formed in the lower deco portion 7b. The height of the outer speaker hole 7c may be lower than the height of the inner speaker hole 33a. The outer speaker hole 7c may be opened in the up and down direction Z to the lower deco portion 7b. The size of the outer speaker hole 7c may be larger than the size of the inner speaker hole 33a. The number of outer speaker holes 7c may be smaller than the number of inner speaker holes 33a.

The charger may comprise an LED module 42 accommodated in the charger body 1.

The LED module 42 may comprise an LED PCB 43 on which an LED is installed, and a diffuser 44 that diffuses light generated from the LED.

The LED PCB 43 may be disposed at the rear of the diffuser 44. The LED PCB 43 may be supported by the diffuser 44.

All or some of the diffuser 44 may be inserted into the upper opening 31e formed in the front body portion 31 of the front body 3, and may be supported by the front body portion 31 of the front body 3.

The diffuser 44 may be disposed between the LED PCB 43 and the light transmitting portion 6a of the upper deco 6, and light diffused by the diffuser 44 may be transmitted through the light transmitting portion 6a of the upper deco 6.

The charger may further comprise an RF PCB 46.

The RF PCB 46 may be disposed on the rear surface of the front body portion 31 of the front body 3.

An RF reader may be installed in the RF PCB 46. The RF reader may be a module for paying the usage fee of the charger.

The charger may further comprise a sensor 48, see FIG. 12 for detecting the connector 28a of the charging cable 28. The sensor 48 may be a connector sensor (or gun sensor) for sensing the connector 28a.

The sensor 48 may sense the connector 28a when the connector 28a of the charging cable 28 is inserted and disposed in the connector holder 30.

The charger body 1 may further comprise a frame 50 accommodated in the inner space S1.

The frame 50 may support various components accommodated inside the charger body 1.

The frame 50 may partition the inside of the charger body 1 into a rear inner space S2 and a front inner space S3.

The space formed between the rear body 2 and the frame 50 may be a rear inner space S2, and the space formed between the frame 50 and the front body 3 may be a front inner space S3.

An opening 51a may be formed in the frame 50. The opening 51a may be an inner opening formed for a metering module described later.

The charger may further comprise a rear waterproof pad 52 that waterproofs between the rear body 2 and the frame 50, and a front waterproof pad 54 that waterproofs between the frame 50 and the front body 3.

The rear waterproof pad 52 may be disposed between the rear body 2 and the frame 50.

The rear waterproof pad 52 may be disposed between the front end of the rear body 2 and the rear end of the frame 50. An opening may be formed inside the rear waterproof pad 52.

The front waterproof pad 54 may be disposed between the frame 50 and the front body 3.

The front waterproof pad 54 may be disposed between the front surface of the frame 50 and the rear end of the front body 3.

The charger may further comprise a supporter 60 coupled to the charger body 1. The supporter 60 may be accommodated in the inner space S1.

The supporter 60 may be coupled to the rear body 2. The supporter 60 may be disposed on the front surface of the rear body portion 21 of the rear body 2 and may be accommodated in the rear inner space S2.

The supporter 60 may be fastened to the rear body portion 21 of the rear body 2 by a fastening member such as a screw.

The charger may comprise a power board 62 and a control board 65.

The power board 62 may be accommodated in the inner space S1. The power board 62 may be fastened to the supporter 60. The power board 62 may be fastened to the supporter 60 by a fastening member such as a screw, and may be disposed on the front surface of the supporter 60.

The power board 62 may be accommodated in the rear inner space S2.

The power board 62 may have a power component disposed on the power board 62.

The power component may apply a current applied through a contact pin 12 to the charging cable 28.

The power board 62 may comprise a power PCB 63 and a terminal block 64 installed on the power PCB 63.

The power PCB 63 may be the main PCB of the charger. The upper portion of the contact pin 12 may be connected to the power PCB 63.

The terminal block 64 may be disposed on the lower front surface of the power PCB 63, and the charging cable 28 may be connected to the terminal block 64.

The control board 65 may be accommodated in the inner space S1. The control board 65 may be integrated with the power board 62.

The charger may further comprise a spacer 66, see FIG. 15 connected to the power board 62.

The spacer 66 may be disposed lengthwise in the front and rear direction X.

The spacer 66 may be connected to the control board 65.

The spacer 66 may separate the control board 65 from the power board 62.

An example of the spacer 66 may comprise a PAM nut.

The control board 65 may be connected to the spacer 66 and may be spaced apart from the power board 62 in the front and rear direction X.

The control board 65 may be spaced apart from the power board 62 in the front and rear direction X by the spacer 66. The control board 65 may be disposed in front of the power board 62 by the spacer 66.

The control board 65 may be integrated with the power board 62 by the spacer 66, and the power board 62 and the control board 65 may be accommodated together in the rear inner space S2.

The control board 65 may control the overall operation of the charger. The control board 65 may comprise a sub-PCB of the charger. The size of the control board 65 may be smaller than the size of the power board 62.

The control board 65 may be connected to a touch display 8, an LED PCB 43, a power PCB 63, etc., by a harness, etc.

The control board 65 may be connected to the power board 62 by a single harness 67.

The power board 62 and the control board 65 may be integrated in multi stages, and may be disposed in the rear body 2 and connected by a single harness 67 to simplify the internal structure of the charger.

The charger may further comprise a metering module.

The metering module may comprise a metering PCB 72 and a metering PCB supporter 73.

The metering PCB 72 may calculate the power usage. The metering PCB 72 may be connected to the metering PCB supporter 73. The metering PCB 72 may be disposed on the front surface of the metering PCB supporter 73.

The metering PCB supporter 73 may support the metering PCB 72.

The metering PCB 72 and the metering PCB supporter 73 may be accommodated in the inner space S1 of the charger body 1.

The metering PCB supporter 73 may be fastened to the rear body portion 21 of the rear body 2 by a fastening member such as a screw.

The metering PCB 72 and the metering PCB supporter 73 may be accommodated in the inner space S1. The metering PCB 72 and the metering PCB supporter 73 may be accommodated in the rear inner space S2.

The metering PCB 72 may be connected to the control board 65 by signal lines and power lines.

The metering module may comprise a metering display 74 and a metering window 75.

The metering display 74 may comprise a PCB and a display unit that displays power usage.

The metering display 74 may be connected to the metering PCB 72 by signal lines and power lines, and may display power usage calculated from the metering PCB 72.

Some or all of the metering window 75 may be disposed in an opening 51a formed in the frame 50.

A space may be formed in the metering window 75 in which the metering display 74 may be accommodated, and the metering display 74 may be inserted into the metering window 75 and supported by the metering window 75.

The metering display 74 and the metering window 75 may be accommodated in the rear inner space S2. The metering display 74 and the metering window 75 may be disposed in the frame 50.

A metering opening 35a, see FIG. 2 may be formed on the front body 3.

The metering opening 35a may be an opening corresponding to the opening 51a of the frame 50.

When the opening 51a of the frame 50 is formed in the left frame of the frame 50, the metering opening 35a formed in the front body 3 may be formed in the left body portion 34 of the front body 3, and the user may check the power usage next to the charger.

When the opening 51a of the frame 50 is formed in the right frame of the frame 50, the metering opening 35a formed in the front body 3 may be formed in the right body portion 35 of the front body 3, and the user may check the power usage from the side of the charger.

The metering module may comprise a metering waterproof pad 76. The metering waterproof pad 76 may be disposed between the metering window 75 and the frame 50. The metering waterproof pad 76 may waterproof the space between the metering window 75 and the frame 50.

The charger may further comprise a reset module.

The reset module may comprise a reset button 81 and a reset PCB 82.

A user or a manager may press the reset button 81.

A reset switch that is switched by the reset button 81 may be installed in the reset PCB 82.

The reset button 81 may be disposed so as not to be visible from the outside of the charger.

The reset button 81 may be accommodated in a button hole formed in the rear body portion 21 of the rear body 2. The user or the manager may dispose a finger between the rear body 2 and the wall W and press the reset button 81 from the rear of the reset button 81.

The reset PCB 82 may be accommodated in the inner space S1 of the charger 1. The reset PCB 82 may be accommodated in the rear inner space S2. The reset PCB 82 may be connected to the control board 65 by a signal line and a power line.

The reset PCB 82 may be disposed on the rear body portion 21 of the rear body 2. The reset PCB 82 may be disposed on the front of the rear body portion 21 of the rear body 2.

The charger may further comprise an output sensor 84.

The output sensor 84 may sense the power of the charging cable 28. The output sensor 84 may be accommodated in the inner space S1 of the charger 1. The output sensor 84 may be accommodated in the rear inner space S2. The output sensor 84 may be connected to the control board 65 by a signal line and a power line.

The charger may comprise a communication module.

The communication module may further comprise a Wi-Fi PCB 86. A WiFi module may be installed in the WiFi PCB 86.

The WiFi PCB 86 may be accommodated in the inner space S1 of the charger 1. The WiFi PCB 86 may be accommodated in the rear inner space S2. The WiFi PCB 86 may be connected to the control board 65 via a signal line and a power line.

The WiFi PCB 86 may be accommodated inside of the frame 50 or the inside of the rear body 2.

The communication module may further comprise an antenna PCB 88. An antenna may be installed in the antenna PCB 88.

The antenna PCB 88 may be accommodated in the inner space S1 of the charger 1. The antenna PCB 88 may be accommodated in the rear inner space S2. The antenna PCB 88 may be connected to the control board 65 via a signal line and a power line.

The antenna PCB 88 may be accommodated inside the frame 50 or inside the rear body 2.

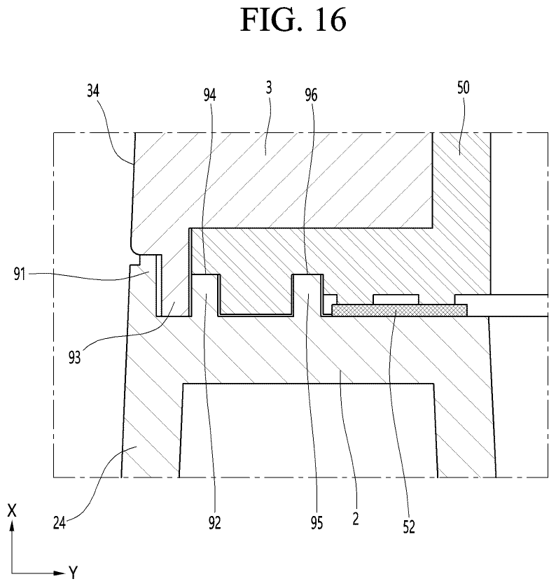

FIG. 16 is a cross-sectional view showing a rear body, a frame and a front frame according to the present embodiment.

The charger may comprise a waterproofing portion that minimizes water penetration between the rear body 2 and the front body 3

A first rib 91 and a second rib 92 may be formed on the rear body 2.

The first rib 91 may protrude forward from the rear body 2.

The second rib 92 may protrude forward from the rear body 2 and may be spaced apart from the first rib 91 in the left and right direction X.

A gap with an open front may be formed between the first rib 91 and the second rib 92.

A third rib 93 may be formed on the front body 3.

The third rib 93 may protrude rearward from the front body 3.

The third rib 93 may be inserted into the gap between the first rib 91 and the second rib 92.

The charger may comprise a waterproofing portion that minimizes water penetration between the frame 50 and the rear body 2.

An outer groove 94 into which the second rib 92 is inserted may be formed in the frame 50.

A fourth rib 95 may be formed in the rear body 2.

The fourth rib 95 may protrude forward from the rear body 2.

The fourth rib 95 may be spaced apart from the second rib 92 in the left and right direction Y.

The fourth rib 95 may be located outside of the rear waterproofing pad 52 based on the center of the left and right direction Y of the rear body 2. The fourth rib 95 may minimize water that has penetrated between the rear body 2 and the frame 50 from flowing to the rear waterproof pad 52.

An inner groove 96 into which the fourth rib 95 is inserted may be formed in the frame 50.

The inner groove 96 may be located inside of the outer groove 94 based on the center of the left and right direction Y of the frame 50.

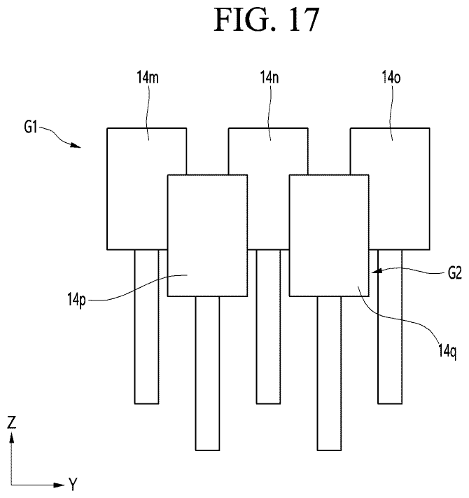

FIG. 17 is a first modified example of a module according to the present embodiment.

A first modification of the module 10 may comprise a group of charging terminals G1 AND G2 in plurality of rows.

The group of charging terminals G1 AND G2 may comprise a group of first-row charging terminals G1 in which a plurality of first-row charging terminals 14m, 14n and 14o are disposed in a single row, and a group of second-row charging terminals G2 in which a plurality of second-row charging terminals 14p and 14q are disposed in a single row.

Each of the plurality of first-row charging terminals 14m, 14n and 14o may be identical to the charging terminals 14 illustrated in FIGS. 9 and 10.

Each of the plurality of second-row charging terminals 14p and 14q may be identical to the charging terminals 14 illustrated in FIGS. 9 and 10.

The plurality of first-row charging terminals 14m, 14n and 14o may be disposed in a row in the left and right direction Y and may be spaced apart from each other in the left and right direction Y.

The plurality of second-row charging terminals 14p and 14q may be disposed in a row in the left and right direction Y and may be spaced apart from each other in the left and right direction Y.

The group of first-row charging terminals G1 and the group of second-row charging terminals G2 may be parallel to each other.

The distance between the group of first-row charging terminals G1 and the rear surface of the module 10 may be different from the distance between the group of second-row charging terminals G2 and the rear surface of the module 10.

The height of the group of first-row charging terminals G1 may be different from the height of the group of second-row charging terminals G2.

The group of first-row charging terminals G1 and the group of second-row charging terminals G2 may overlap in the front and rear direction X or the up and down direction Z or in the oblique direction between the front and rear direction X and the up and down direction Z.

The number of the first-row charging terminals 14m, 14n and 14o is different from the number of the second-row charging terminals 14p and 14q.

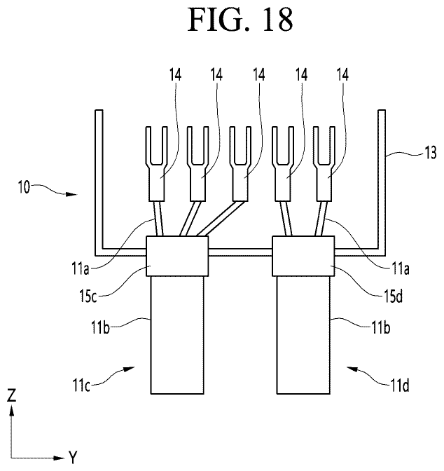

FIG. 18 is a second modified example of a module according to the present embodiment.

The second variation of the module 10 may have a number of inlet cables that are different from the number of inlet cable 11 of the module 10 illustrated in FIG. 8.

The second variation of the module 10 may comprise a plurality of inlet cables 11c and 11d.

Each of the plurality of inlet cables 11c and 11d may comprise a plurality of inlet lines 11a and an outer shell 11b.

Hereinafter, one 11c of the plurality of inlet cables 11c and 11d may be referred to as a first inlet cable, and the other 11d of the plurality of inlet cables 11c and 11d may be referred to as a second inlet cable.

The number of inlet lines 11a comprised in the first inlet cable 11c may be different from the number of inlet lines 11a comprised in the second inlet cable 11d.

The thickness of the first inlet cable 11c may be different from the thickness of the second inlet cable 11d.

The first inlet cable 11c may comprise the outer shell 11b, and an R-phase inlet line, an S-phase inlet line, and a T-phase inlet line housed together inside the outer shell 11b.

The second inlet cable 11d may comprise the outer shell 11b, and an N-phase neutral phase inlet line, and a G-phase ground inlet line housed together inside the outer shell 11b.

The thickness of the first inlet cable 11c may be thicker than the thickness of the second inlet cable 11d.

A second variation of the module 10 may comprise a number of glands equal to the number of incoming cables.

The second variation of the module 10 may comprise a plurality of glands 15c and 15d.

The structure of each of the plurality of glands 15c and 15d may be the same as the structure of the gland 15 illustrated in FIG. 9.

The size of each of the plurality of glands 15c and 15d may be smaller than the size of the gland 15 illustrated in FIG. 9.

The plurality of glands 15c and 15d may be mounted spaced apart from each other in the housing 13.

The plurality of glands 15c and 15d may comprise a first gland 15c through which a first inlet cable 11c passes, and a second gland 15d through which a second inlet cable 11d passes.

The first gland 15c and the second gland 15d may be spaced apart in the left and right direction Y.

The second modified example of the module 10 may have a configuration that is identical or similar to the module 10 illustrated in FIG. 8 except for the plurality of inlet cables 11c and 11d and the plurality of glands 15c and 15d, and the same symbols are used and a detailed description thereof is omitted.

The second modified example of the module 10 may minimize the thickness of each of the plurality of inlet cables 11c and 11d by using the plurality of inlet cables 11c and 11d and the plurality of glands 15c and 15d

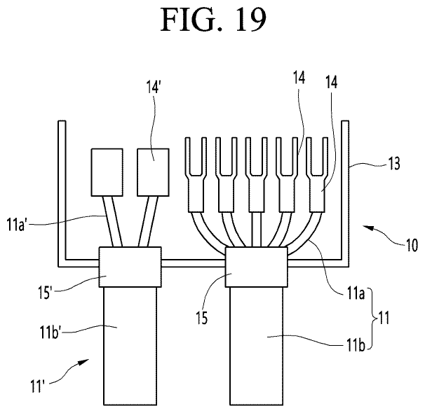

FIG. 19 is a third modified example of a module according to the present embodiment.

A third variation of the module 10 may comprise an additional inlet cable 11′, an additional gland 15′, and an additional contact terminal 14′, and other configurations and functions other than the additional inlet cable 11′, the additional gland 15′, and the additional contact terminal 14′ may be similar or identical to the module 10 illustrated in FIG. 9, and the same symbols are used and detailed descriptions thereof are omitted.

The additional inlet cable 11′ may be used for various purposes, such as signal lines.

The additional inlet cable 11′ may comprise an outer shell 11b′ and at least one communication line 11a′ surrounded by the outer shell 11b′.

The additional inlet cable 11′ may be spaced apart from the inlet cable 11.

An example of the communication line 11a′ may be a LAN line. The additional inlet cable 11′ may comprise a plurality of communication lines 11a'.

The plurality of communication lines 11a′ may comprise a first communication line and a second communication line.

The communication line 11a′ may not be configured inside the inlet cable 11 for noise shielding, and may configure an additional inlet cable 11′.

The additional inlet cable 11′ may pass through an additional gland 15′.

The additional gland 15′ may be installed in the housing 13. The additional gland 15′ may be installed spaced apart from the gland 15.

A third variation of the module 10 may further comprise an additional contact terminal 14′ to which the communication line 11a′ is connected. The number of the additional contact terminals 14′ may be equal to the number of the communication lines 11a'.

The additional contact terminal 14′ may be spaced apart from the contact terminal 14.

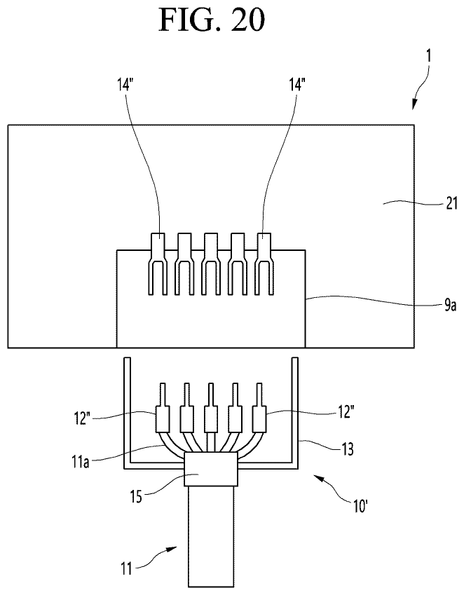

FIG. 20 is a modified example of a charger according to the present embodiment.

The charger illustrated in FIG. 20 may comprise a contact pin 12″ comprised in the module 10′ and a contact terminal 14″ accommodated in the charger body 1.

A modified example of the charger may be similar or identical to the charger illustrated in FIGS. 1 to 15 in terms of configuration and function other than the contact pin 12″ and the contact terminal 14″, and the same reference numerals are used and a description thereof is omitted.

The contact pin 12″ may be disposed lengthwise in the up and down direction Z inside the housing 13 of the module 10′.

The inlet line 11a of the inlet cable 11 may be connected to the contact pin 12″.

The contact terminal 14″ may be installed on the power board 62 disposed in the charger body 1.

In the modification of the charger, when the module 10′ is raised, the contact pin 12″ disposed inside the module 10′ may come into contact with the contact terminal 14″ accommodated in the charger body 1.

According to this embodiment, since the module can be serviced after being separated from the charger body without opening or disassembling the charger body, the convenience of servicing the module can be increased.

In addition, while maintaining the module at the charger installation location, an owner of the charger can service a new charging body or replace the charging body with a new model after separating the charging body from the module.

In addition, since the module can be used for common use, and when it is serviced with a new charging module or replaced with a new model, the owner of the charger does not need to separately construct an inlet cable, and setup of the inlet line, is unnecessary, and cost and time can be saved.

In addition, since the gland can be fixed to the housing by a bolt through which the inlet cable passes and a nut fastened to the bolt, assembly of the gland is easy.

In addition, the contact pin is a bus bar, and the contact terminal comprises an elastic body with which the contact pin comes into contact, so that the contact pin and the contact can be reliably connected.

In addition, since the housing is guided to slide up and down on the sliding guide of the charger body, the module can be easily mounted, and the operator can easily insert the module.

In addition, the first fastening portion formed on the housing and the second fastening portion of the charger body are fastened with fastening members, and the module can be easily mounted.

In addition, the cover body conceals the contact pins, so that safety accidents that may occur when the contact pins are exposed can be minimized.

In addition, the inside of the module can be waterproofed by the inner waterproof gasket.

In addition, the space between the charger body and the module can be waterproofed by the upper waterproof gasket.

In addition, the charger body has a simple appearance comprising the rear body and the front body.

In addition, the front body can be protected by the upper deco and the lower deco, and it is easy to change the front design of the charger.

In addition, the touch display can display information through the space between the upper deco and the lower deco, and the user can operate the touch display.

In addition, the front body can be opened, and the connector holder can be serviced or replaced.

In addition, an outer speaker hole is formed in the lower deco portion of the lower deco to minimize rainwater infiltration, the front of the charger can be made as simple as possible, and the front design of the charger can be improved. In addition, the mounting portion formed on the back of the rear body is mounted on a mounter that is fixed to the wall, so that the installation of the charger is easy.

In addition, the space between the rear body and the frame can be waterproofed by the rear waterproof pad, and the area between the frame and the front body can be waterproofed by the front waterproof pad.

In addition, the third rib formed on the front body is inserted between the first rib formed on the rear body and the second rib, so that the space between the rear body and the front body can be reliably waterproofed.

In addition, the power board and the control board can be integrated in a state of being spaced apart in the front and rear direction by the spacer, and the power board and the control board are connected by a harness, so that the structure is simple.

The above-disclosed subject matter is to be considered illustrative, and not restrictive, and the appended claims are intended to cover all such modifications, enhancements, and other implementations, which fall within the scope of the present disclosure.

Therefore, the embodiments disclosed in the present invention are not intended to limit the technical idea of the present invention but to explain it, and the scope of the technical idea of the present invention is not limited by these embodiments.

The scope of the present disclosure is defined by the following claims, and all differences within the scope will be construed as being comprised in the present disclosure.

What is claimed is:

1. A charger comprising;
a charger body;
a contact pin disposed at the charger body; and
a rear module configured to be detachably coupled to a rear of the charger body,
wherein the rear module comprises:
a housing; and
a contact terminal disposed inside the housing and configured to contact the contact pin when the rear module is coupled to the rear of the charger body.

2. The charger of claim 1, wherein the rear module further comprises a gland coupled to the housing and configured to allow an inlet cable to pass therethrough.

3. The charger of claim 2, wherein the gland comprises:
a bolt penetrating the housing and through which the inlet cable passes, and
wherein the rear module comprises a nut accommodated inside the housing and fastened to the bolt.

4. The charger of claim 1,
wherein the contact pin is a bus bar, and
wherein the contact terminal comprises an elastic body configured to contact the contact pin.

5. The charger of claim 1,
wherein the charger body comprises a sliding guide configured to guide the housing when sliding upward to be coupled to the charger body such that the contact terminal contacts the contact pin.

6. The charger of claim 1,
wherein the housing comprises a first fastening portion configured to be fastened to a second fastening portion located at the charger body by a fastening member.

7. The charger of claim 1,
wherein the charger body comprises a cover body concealing the contact pin.

8. The charger of claim 1,
wherein a lower portion of the rear module protrudes toward a forward direction of the charger.

9. The charger of claim 1, wherein the rear module comprises:
a cover configured to define a space in the housing;
an inner waterproof gasket disposed between the cover and the housing; and
an upper waterproof gasket disposed at an upper end of the housing.

10. The charger of claim 1, wherein the charger body comprises:
a rear body and a front body, wherein an inner space is defined between the rear body and the front body.

11. The charger of claim 10, wherein the front body comprises:
a front body portion;
an upper body portion formed at an upper end of the front body portion; and
a lower body portion formed at a lower end of the front body portion.

12. The charger of claim 11, wherein the charger body further comprises:
an upper deco covering an upper portion of the front body portion; and
a lower deco covering a lower portion of the front body portion.

13. The charger of claim 12, further comprising:
a touch display disposed at a middle of the front body portion to be between the upper deco and the lower deco.

14. The charger of claim 12, further comprising:
a connector holder disposed at the front body portion,
wherein the lower deco and the front body portion are each formed to define an opening through which a connector of a charging cable is allowed to pass therethrough.

15. The charger of claim 12, further comprising:
a speaker disposed at the front body portion,
wherein an inner speaker hole is formed at the lower body portion,
wherein the lower deco comprises a lower deco portion disposed below the lower body portion, and
wherein an outer speaker hole is formed at the lower deco portion.

16. The charger of claim 10, further comprising:
a mounting portion disposed at a rear surface of the rear body and configured to be mounted to a wall.

17. The charger of claim 10, further comprising:
a frame accommodated in the inner space;
a rear waterproof pad between the rear body and the frame; and
a front waterproof pad between the frame and the front body.

18. The charger of claim 10,
wherein the rear body is provided with a first rib and a second rib protruding forward and spaced apart from each other in a left and right direction, and
wherein the front body is provided with a third rib configured to be inserted into a gap defined between the first rib and the second rib.

19. The charger of claim 10, further comprising:
a supporter coupled to the rear body; and
a power board connected to the supporter,
wherein the contact pin is connected to the power board.

20. The charger of claim 1, further comprising:
a power board accommodated inside the charger body;
a spacer connected to the power board; and
a control board connected to the spacer and spaced apart from the power board in a front and rear direction,
wherein the power board and the control board are connected by a harness.
